(19) United States
(12) Patent Application Publication
(10) Pub. No.: US 2014/0320370 A1
(43) Pub. Date: Oct. 30, 2014

(54) PLANAR INVERTED-F ANTENNA

(71) Applicant: Arcadyan Technology Corporation, Hsinchu (TW)

(72) Inventors: Chih-Yung HUANG, Taichung City (TW); Kuo-Chang LO, Miaoli County (TW)

(73) Assignee: ARCADYAN TECHNOLOGY CORPORATION, Hsinchu (TW)

(21) Appl. No.: 14/226,313

(22) Filed: Mar. 26, 2014

(30) Foreign Application Priority Data
Apr. 24, 2013 (TW) 102114601

(51) Int. Cl. H01Q 9/04

(52) U.S. Cl. CPC H01Q 9/0407
USPC 343/848; 343/700 MS

(57) ABSTRACT

A PIFA includes a substrate having a first side, a second side, a third side, and a fourth side, a ground portion, a radiation body, a shortening portion, a shortening extension portion, and a ground extension portion. The first side is opposite to the third side, and the second side is opposite to the second side. The ground portion is adjacent to all of the first side, all of the fourth side, and a part of the third side. The radiation body is adjacent to the second side. The shortening portion is adjacent to a part of the second side and a part of the third side, and is electrically coupled to the radiation body and the ground portion. The radiation body is extended from the shortening portion toward the first side. The ground extension portion is extended from the ground portion toward the second side.

This application claims the benefit of Taiwan application Serial No. 102114601, filed Apr. 24, 2013, the subject matter of which is incorporated herein by reference.

### BACKGROUND OF THE INVENTION

1. Field of the Invention

The invention relates in general to an antenna, and more particularly to a planar inverted-F antenna (PIFA).

2. Description of the Related Art

In a wireless communication device, an antenna for transceiving wireless signals is a crucial component. Characteristics including radiation efficiency, directionality, bandwidth and impedance matching of the antenna critically affect the performance of the antenna. Current antennas are categorized into external antennas and internal antennas. Since external antennas are prone to bending or fracturing caused by collisions, the number of wireless communication devices adopting internal antennas is increasing.

With an internal antenna, not only a wireless communication apparatus is given a simple shape, but also possibilities of bending and fracturing an externally placed antenna by an alien object are eliminated. Thus, internal antennas have gradually become an application trend for wireless communication apparatuses. A three-dimensional antenna is a conventional internal antenna. However, costs of three-dimensional antennas may remain high as conventional three-dimensional antennas are manufactured by molds. Further, when connecting manufactured three-dimensional antennas to a system circuit, frequency shifts are often generated and flexible adjustments cannot be made.

### SUMMARY OF THE INVENTION

The invention is directed to a planar inverted-F antenna (PIFA).

According to the present invention, a planar inverted-F antenna is provided. The planar inverted-F antenna includes a substrate, a ground portion, a radiation body, a shortening portion, a shortening extension portion, and a ground extension portion. The substrate includes a first side, a second side, a third side, and a fourth side. The first side is opposite to the third side, and the second side is opposite to the second side. The ground portion is adjacent to all of the first side, all of the fourth side, and a part of the third side. The radiation body is adjacent to the second side. The shortening portion is adjacent to a part of the second side and a part of the third side, and is electrically coupled to the radiation body and the ground portion. The radiation body is extended from the shortening portion toward the first side. The ground extension portion is extended from the ground portion toward the second side.

According to the present invention, a planar inverted-F antenna is further provided. The planar inverted-F antenna includes a substrate, a ground portion, a radiation body, a shortening portion, a shortening extension portion, and a ground extension portion. The substrate includes a first side, a second side, a third side, and a fourth side. The first side is opposite to the third side, and the second side is opposite to the second side. The ground portion is adjacent to all of the first side, all of the fourth side, and a part of the third side. The radiation body is adjacent to the second side. The shortening portion is adjacent to a part of the second side and a part of the third side, and is electrically coupled to the radiation body and the ground portion. The radiation body is extended toward the first side. The shortening extension portion is adjacent to the second side, and is extended from the shortening portion toward the third side. The ground extension portion is extended from a junction of the ground portion and the shortening portion toward the second side and the first side, respectively.

According to the present invention, a planar inverted-F antenna is provided. The planar inverted-F antenna includes a substrate, a ground portion, a radiation body, a shortening portion, shortening extension portion, a ground extension portion, a signal feed point, and a ground point. The substrate includes a first side, a second side, a third side, and a fourth side. The first side is opposite to the third side, and the second side is opposite to the fourth side. The ground portion is adjacent to all of the first side, all of the fourth side, and a part of the third side. The radiation body is adjacent to the second side. The shortening portion is adjacent to a part of the second side and a part of the third side, and is electrically coupled to the radiation body and the ground portion. The radiation body is extended from the shortening portion toward the first side. The shortening extension portion is adjacent to the second side, and is extended form the shortening portion toward the third side. The ground extension portion is extended from a junction of the ground portion and the shortening portion toward the second side and the first side, respectively. The radiation body near the junction with the shortening portion further includes a signal feed point. The ground extension portion further includes a ground point corresponding to a position of the signal feed point.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a wireless communication device according to a first embodiment;

FIG. 2 is an elevational diagram of a planar inverted-F antenna according to the first embodiment;

FIG. 3 is a front view of a planar inverted-F antenna according to the first embodiment;

FIG. 4 is a rear view of a planar inverted-F antenna according to the first embodiment;

FIG. 5 is a test diagram of a voltage standing wave ratio (VSWR) of a planar inverted-F antenna according to the first embodiment;

FIG. 6 is a schematic diagram of a coaxial cable connected to a planar inverted-F antenna; and

FIG. 7 is a front view of a planar inverted-F antenna according to a second embodiment.

### DETAILED DESCRIPTION OF THE INVENTION

### First Embodiment

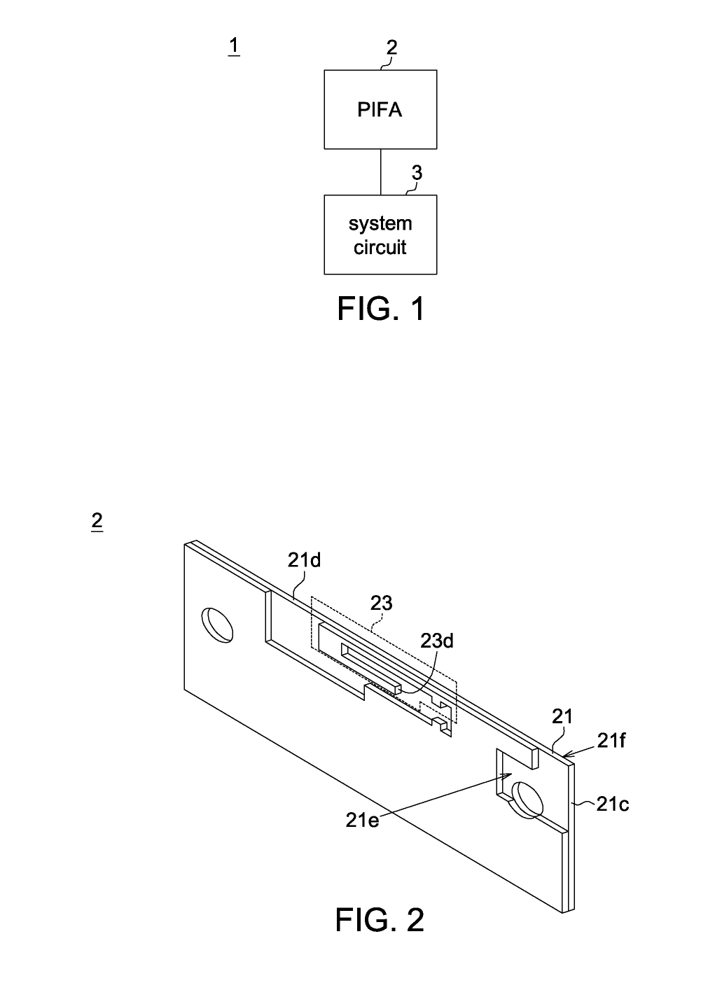

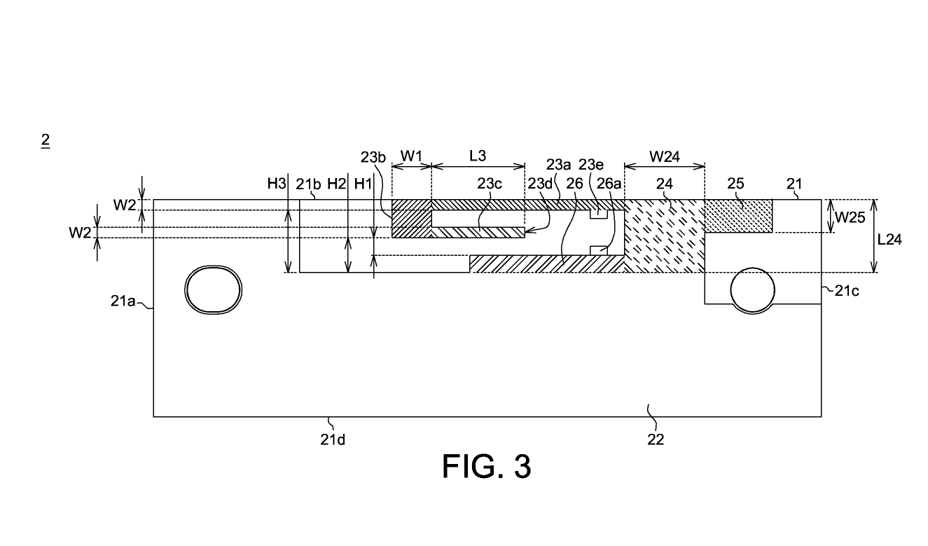

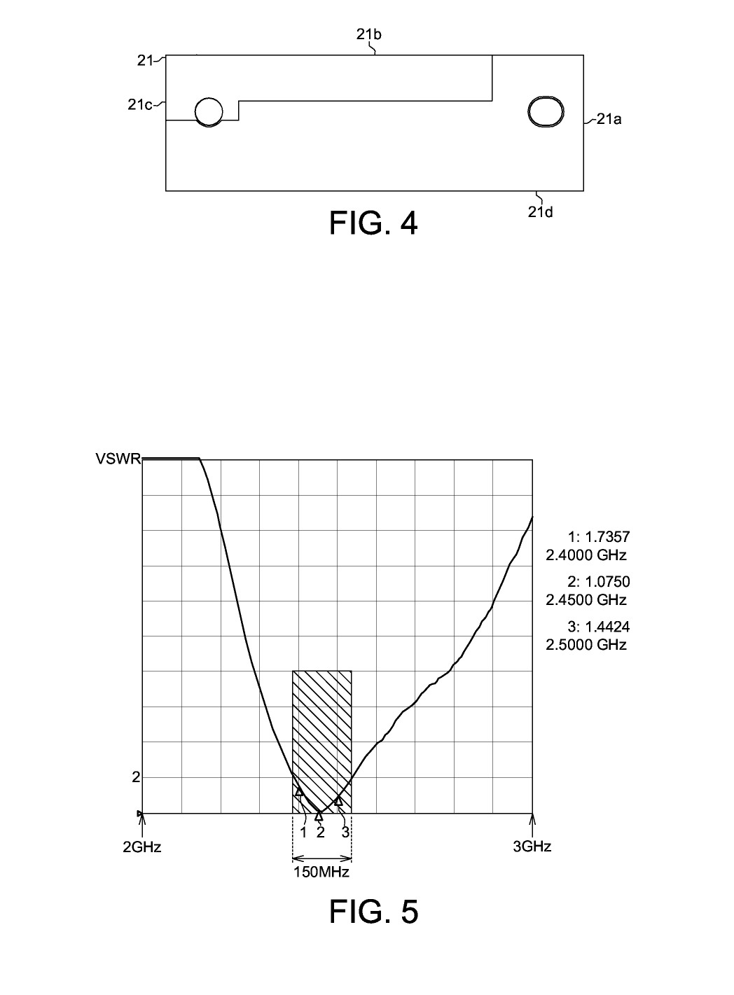

Referring to FIGS. 1, 2, 3 and 4, FIG. 1 shows a block diagram of a planar inverted-F antenna according to a first embodiment; FIG. 2 shows an elevational view of a planar inverted-F antenna according to the first embodiment; FIG. 3 shows a front view of a planar inverted-F antenna according to the first embodiment; FIG. 4 shows a rear view of a planar inverted-F antenna according to the first embodiment. For example, a wireless communication device 1 is a personal digital assistant (PDA), an electronic book, a laptop computer, a portable handset, a wireless base station, or a video/audio player having a Wi-Fi module. The wireless communication device 1 includes a planar inverted-F antenna (PIFA) 2 and a system circuit 3. The system circuit 3 is coupled to the planar inverted-F antenna 2, and transceives wireless signals via the planar inverted-F antenna 2.

The planar inverted-F antenna 2 includes a substrate 21, a ground portion 22, a radiation portion 23, a shortening portion 24, a shortening extension portion 25, and a ground extension portion 26. For example, the substrate 21 is a printed circuit board; the ground portion 22, the radiation body 23, the shortening portion 24, the shortening extension portion 25 and the ground extension portion 26 are formed by etching the printed circuit board. The substrate 21 includes a first side 21a, a second side 21b, a third side 21c, a fourth side 21d, a first surface 21e, and a second surface 21f. The first side 21a is opposite to the third side 21c, and the second side 21b is opposite to the fourth side 21d. The first surface 21e is opposite to the second surface 21f. The ground portion 22, the radiation body 23, the shortening portion 24, the shortening extension portion 25 and the ground extension portion 26 are disposed at the first surface 21e, as shown in FIG. 3. At the second surface 21f, areas corresponding to the radiation body 23, the shortening portion 24, the shortening extension portion 25 and the ground extension portion 26 are not disposed with a metal ground plane, as shown in FIG. 4. The ground portion 22 is adjacent to all of the first side 21a, all of the fourth side 21d, and a part of the third side 21c. The radiation body 23 is adjacent to the second side 21b. The shortening portion 24 is adjacent to a part of the second side 21b and a part of the third side 21c, and is electrically coupled to the radiation body 23 and the ground portion 22. The radiation body 23 is extended from the shortening portion 24 toward the first side 21a. The shortening extension portion 25 is adjacent to the second side 21b, and is extended from the shortening portion 24 toward the third side 21c. A width W25 of the shortening extension portion 25 is smaller than a length L24 of the shortening portion 24. The ground extension portion 26 is extended from the ground portion 22 toward the second side 21b. Further, the ground extension portion 26 is extended from a junction of the ground portion 22 and the shortening portion 24 toward the second side 21b and the first side 21a, respectively. The shortening extension portion 25 and the ground extension portion 25 are for adjusting impedance matching. The impedance of the planar inverted-F antenna 2 may be adjusted by reducing the shortening extension portion 25 and the ground extension portion 26.

The shape of the radiation body 23 has a bend, with an opening facing the shortening portion 24. In the first embodiment, the shape of the radiation body 23 having a bend is taken as an example for illustrations. The radiation body 23 appears as a U-shape, and includes a first microstrip line 23a, a second microstrip line 23b, a third microstrip line 23c, an open end 23d, and a signal feed point 23e. The signal feed point 23e is near the junction of the radiation body 23 and the shortening portion 24. A distance H1 from the open end 24d to the ground extension portion 26 is smaller than a distance H2 from the open end 23d to the ground portion 22. The first microstrip line 23a has one end connected to the shortening portion 24, and is extended from the shortening portion 24 toward the first side 21a and further toward the second microstrip line 23b. The second microstrip line 23b is extended from the first microstrip line 23a toward the fourth side 21d and further toward the third microstrip line 23c. The third microstrip line 23c is extended from the second microstrip 23b toward the third side 21c and further to the open end 23d.

The open end 23d is located between the first microstrip line 23a and the ground extension portion 26. The ground extension portion 26 further includes a ground point 26a corresponding to the signal feed point 23e. The distance H1 from the open end 23d to the ground extension portion 26 is smaller than a distance H3 from the first microstrip 23a to the ground extension portion 26. The third microstrip line 23c and the ground extension portion 26 form capacitive coupling, which facilitates the reduction on the height of the planar inverted-F antenna 2. A width W1 of the second microstrip line 23b is greater than a width W2 of the first microstrip line 23a and the third microstrip line 23c. A width W24 of the shortening portion 24 is greater than the width W2 of the first microstrip line 23a and the third microstrip line 23c, and is greater than the width W1 of the second microstrip line 23b.

In the occurrence of a frequency shift after coupling the system circuit 3 to the planar inverted-F antenna 2, an operating frequency of the planar inverted-F antenna 2 may be adjusted by modifying the width W1 of the second microstrip 23b or a length L3 of the third microstrip line 23c. When the operating frequency is greater than a predetermined frequency after coupling the system circuit 3 to the planar inverted-F antenna 2, the width W1 of the second microstrip line 23b may be decreased to correspondingly increase the operating frequency of the planar inverted-F antenna 2. Conversely, when the operating frequency of the planar inverted-F antenna 2 is greater than the predetermined frequency after coupling the system circuit 3 to the planar inverted-F antenna 2, the length L3 may be decreased to correspondingly reduce the operating frequency of the planar inverted-F antenna 2. As such, the frequency shift can be mitigated by adjusting the width W1 of the second microstrip line 23b or the length L3 of the third microstrip line 23c.

FIG. 5 shows a test diagram of a voltage standing wave ratio (VSWR) of a planar inverted-F antenna according to the first embodiment. A test diagram of the VSWR of the foregoing planar inverted-F antenna 2 is as depicted in FIG. 5. Referring to FIGS. 3 and 5, when the planar inverted-F antenna 2 operates at frequencies 2.4 GHz, 2.45 GHz and 2.5 GHz, respectively, the VSWR is 1.7357, 1.075 and 1.4424, respectively. It is concluded that, when the planar inverted-F antenna 2 operates at a frequency range between 2.39 GHz and 2.54 GHz, the VSWR of the planar inverted-F antenna 2 is smaller than 2.

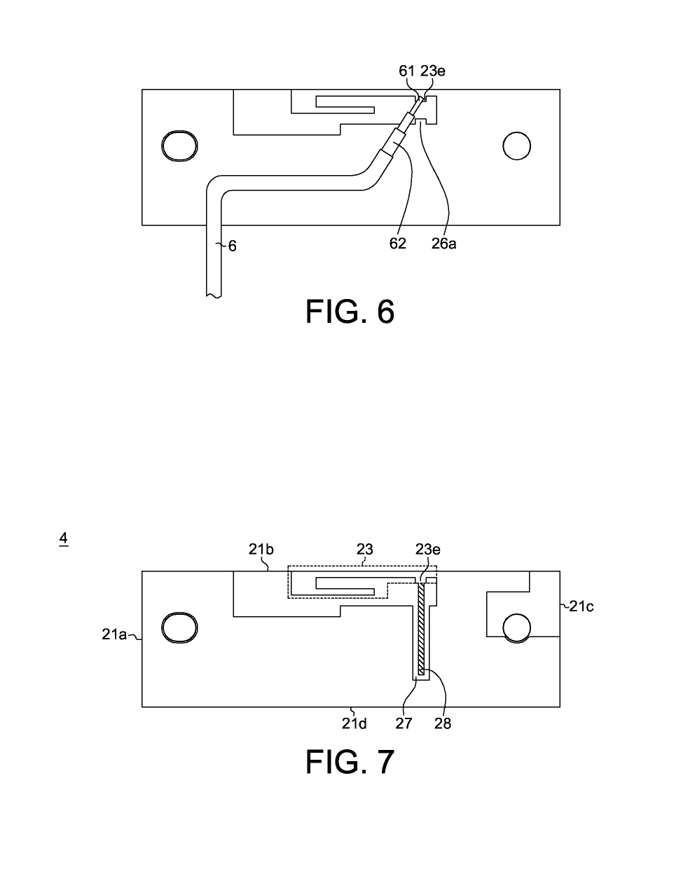

FIG. 6 shows a schematic diagram of a coaxial cable connected to a planar inverted-F antenna. Referring to FIGS. 3 and 6, the radiation body 23 further includes a signal feed point 23e, and the ground extension portion 26 further includes a ground point 26a. A core 61 of the coaxial cable 6 is connected to the signal feed point 23e, and a woven shield 62 of the coaxial cable 6 is connected to the ground point 26a.

### Second Embodiment

FIG. 7 shows a front view of a planar inverted-F antenna according to a second embodiment. Referring to FIGS. 3 and 7, a main difference of the second embodiment from the first embodiment is that, the ground portion 22 and the ground extension portion 26 of a planar inverted-F antenna 4 further include a gap 27, and the planar inverted-F antenna 4 further includes a signal feed portion 28. The signal feed portion 28 is extended from the signal feed point 23e toward the fourth side 21c and further toward the gap 27. The ground extension portion 26 is formed by etching a printed circuit board, and replaces the coaxial cable in the first embodiment.

The foregoing planar inverted-F antenna not only occupies a small space in a wireless communication device, but can also be produced without involving numerous molds, thereby promoting the reduction in production costs. Further, the foregoing planar inverted-F antenna is capable of adaptively adjusting its operating frequency in response to different environments and thus mitigating frequency shifts.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A planar inverted-F antenna, comprising:
a substrate, comprising a first side, a second side, a third side and a fourth side; wherein the first side is opposite to the third side, and the second side is opposite to the fourth side;
a ground portion, adjacent to all of the first side, all of the fourth side and a part of the third side;
a radiation body, adjacent to the second side;
a shortening portion, adjacent to a part of the second side and a part of the third side, electrically coupled to the radiation body and the ground portion;
wherein the radiation body is extended from the shortening portion toward the first side; and
a ground extension portion, extended from the ground portion toward the second side.

2. The planar inverted-F antenna according to claim 1, wherein a shape of the radiation body has at least one bend, with an opening facing the shortening portion.

3. The planar inverted-F antenna according to claim 2, wherein the shape of the radiation body appears as a U-shape.

4. The planar inverted-F antenna according to claim 1, wherein the radiation body comprises an open end, and a distance from the open end to the ground extension portion is smaller than a distance from the open end to the ground portion.

5. The planar inverted-F antenna according to claim 4, wherein the radiation body further comprises:
a first microstrip line, having one end connected to the shortening portion, extended from the shortening portion toward the first side;
a second microstrip line, to which the first microstrip line is extended, the second being extended from the first microstrip line toward the fourth side; and
a third microstrip line, to which the second microstrip line is extended, the third microstrip line being extended from the second microstrip line toward the third side and further to the open end.

6. The planar inverted-F antenna according to claim 6, wherein a width of the second microstrip line is greater than widths of the first microstrip line and third microstrip line.

7. The planar inverted-F antenna according to claim 5, wherein the open end is located between the first microstrip line and the ground extension portion.

8. The planar inverted-F antenna according to claim 5, wherein the distance from the open end to the ground extension portion is smaller than a distance from the first microstrip line to the ground extension portion.

9. The planar inverted-F antenna according to claim 5, wherein an operating frequency of the planar inverted-F antenna increases as a length of the third microstrip line decreases.

10. The planar inverted-F antenna according to claim 5, wherein an operating frequency of the planar inverted-F antenna reduces as a width of the second microstrip line decreases.

11. The planar inverted-F antenna according to claim 5, wherein a width of the shortening portion is greater than widths of the first microstrip line, the second microstrip line and the third microstrip line.

12. The planar inverted-F antenna according to claim 1, wherein the ground portion and the ground extension portion comprise a gap, the radiation body further comprises a signal feed point, the planar inverted-F antenna further comprises a signal feed portion, and the signal feed portion is extended from the signal feed point toward the fourth side and further to the gap.

13. The planar inverted-F antenna according to claim 1, further comprising:
a shortening extension portion, adjacent to the second side, extended from the shortening portion toward the third side.

14. The planar inverted-F antenna according to claim 13, wherein a width of the shortening extension portion is smaller than a length of the shortening portion.

15. The planar inverted-F antenna according to claim 13, wherein the substrate further comprises a first surface and a second surface; the ground portion, the radiation body, the shortening portion, the shortening extension portion and the ground extension portion are disposed at the first surface; at the second surface, areas corresponding to the radiation body, the shortening portion, the shortening extension portion and the ground extension portion are not provided with a metal ground plane.

16. The planar inverted-F antenna according to claim 13, wherein the shortening extension portion and the ground extension portion are for adjusting impedance matching.

17. The planar inverted-F antenna according to claim 1, wherein the ground extension portion is extended from a junction of the ground portion and the shortening portion toward the second side and the first side, respectively.

18. The planar inverted-F antenna according to claim 1, wherein the radiation body further comprises a signal feed point near a junction of the radiation body and the shortening portion.

19. The planar inverted-F antenna according to claim 18, wherein the ground extension portion further comprises a ground point corresponding to the signal feed point.
